(19) United States
(12) Patent Application Publication
(10) Pub. No.: US 2026/0005455 A1
(43) Pub. Date: Jan. 1, 2026

(54) CONNECTOR AND DISPLAY DEVICE INCLUDING THE SAME

(71) Applicant: Samsung Display Co., Ltd., Yongin-si (KR)

(72) Inventors: Bo Bae SIM, Yongin-si (KR); Jeong Min SEO, Yongin-si (KR); Tae Gil KANG, Yongin-si (KR); Byung Jin KIM, Yongin-si (KR)

(21) Appl. No.: 19/082,184

(22) Filed: Mar. 18, 2025

(30) Foreign Application Priority Data
Jun. 26, 2024 (KR) 10-2024-0083574
Aug. 7, 2024 (KR) 10-2024-0105183

(51) Int. Cl. H01R 12/70; H01R 12/71; H01R 13/08

(52) U.S. Cl. CPC H01R 12/7076; H01R 12/716; H01R 13/08

(57) ABSTRACT

A connector includes a case in which an open area is formed, and an actuator rotatably disposed in the open area of the case to open and close at least a portion of the open area through the rotation, wherein the actuator comprises a hook extending from the actuator in a direction perpendicular to a direction to which a rotation axis extends, and wherein the case comprises a locking portion in which the hook is inserted when the actuator closes at least the portion of the open area through the rotation.

### CROSS-REFERENCE TO RELATED APPLICATION

This application claims priority to Korean Patent Application No. 10-2024-0083574 filed on Jun. 26, 2024, and Korean Patent Application No. 10-2024-0105183 filed on Aug. 7, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a connector and a display device including the same.

### 2. Description of the Related Art

A display device such as a TV or a monitor that outputs video information includes an image display device that displays an image and a circuit device that outputs a video signal to display the image. As the information society develops, demands for display devices become more diverse, and the use of flat panel display devices such as liquid crystal display devices and organic light emitting display devices is increasing. Flat panel display devices include a display panel comprised of a plurality of pixels and a circuit unit that supplies signals to the display panel.

A display panel includes a substrate on which signal lines for transmitting signals to implement images and switching elements for driving pixels are formed.

The circuit unit includes a system that supplies signals and power to implement images, a control circuit board including a controller that converts signals supplied from the system into signals to be supplied to the display panel, and a driving circuit board that processes the converted signals from the control circuit board to transmit to the display panel.

The control circuit board and the driving circuit board may be connected by a cable so that the signal converted from the control circuit board can be transmitted to the driving circuit board. The cable may be connected to a connector disposed on the control circuit board and the driving circuit board to be fixed to the control circuit board and the driving circuit board.

### SUMMARY

Aspects of the present disclosure provide a connector capable of preventing a cable from disconnecting from the connector even when a portion of the connector is deformed by the heat generated from the cable.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, a connector includes a case in which an open area is formed, and an actuator rotatably disposed in the open area of the case to open and close at least a portion of the open area through the rotation, wherein the actuator includes a hook extending from the actuator in a direction perpendicular to a direction to which a rotation axis extends, and wherein the case includes a locking portion in which the hook is inserted when the actuator closes at least the portion of the open area through the rotation.

The open area includes a cable entry portion providing a space for a cable to enter, and a cable seating portion connected to the cable entry portion and providing a space for the cable that entered inside the case through the cable entry portion to be mounted.

The locking portion is recessed from an inner surface of the case in a direction to which the hook extends.

The locking portion is provided in plural number and the plurality of locking portions are spaced apart from each other so that the cable entry portion is disposed therebetween.

The case is disposed on one surface of a circuit board, and wherein the case further includes a plurality of connection pins connected to the circuit board and disposed in the cable seating portion.

The actuator further includes a plurality of connection pin insertion portions in which the plurality of connection pins are inserted.

The actuator further includes a rotation portion rotatably disposed on the cable seating portion; and an opening/closing portion extending from the rotation portion to open/close at least a portion of the cable entry portion through the rotation.

The hook extends from the rotation portion.

The hook is provided in plural number and the plurality of hooks are spaced apart from each other so that the opening/closing portion is disposed therebetween.

The opening/closing portion extends in a direction to which the hook extends from the rotation portion.

After the open area of the case is open and the cable is mounted on the cable seating portion through the cable entry portion, the actuator is rotated so that the cable mounted on the cable seating portion is pressed by the rotation portion and the cable disposed in the cable entry portion is pressed by the opening/closing portion.

According to an aspect of the present disclosure, a display device includes a display panel, a driving circuit board connected to the display panel, a cable connected to the driving circuit board, a control circuit board connected to the cable, and a connector disposed on the driving circuit board or the control circuit board to connect the cable to the driving circuit board or the control circuit board, wherein the connector includes a case in which an open area is formed, and an actuator rotatably disposed in the open area of the case to open and close at least a portion of the open area through the rotation, wherein the actuator includes a hook extending from the actuator in a direction perpendicular to a direction to which a rotation axis extends, and wherein the case comprises a locking portion in which the hook is inserted when the actuator closes at least the portion of the open area through the rotation.

The open area includes a cable entry portion providing a space for the cable to enter, and a cable seating portion connected to the cable entry portion and providing a space for the cable that entered inside the case through the cable entry portion to be mounted.

The locking portion is recessed from an inner surface of the case in a direction to which the hook extends.

The locking portion is provided in plural number and the plurality of locking portions are spaced apart from each other so that the cable entry portion is disposed therebetween.

The case is disposed on one surface of the driving circuit board or the control circuit board, and wherein the case further comprises a plurality of connection pins connected to the driving circuit board or the control circuit board and extending toward the cable seating portion.

The actuator further includes a rotation portion rotatably disposed on the cable rotation portion, and opening/closing portion extending from the rotation portion to open/close at least a portion of the cable entry portion through the rotation.

The hook extends from the rotation portion.

The hook is provided in plural number and the plurality of hooks are spaced apart from each other so that the opening/closing portion is disposed therebetween.

According to an aspect of the present disclosure, an electronic device includes a display panel, a driving circuit board connected to the display panel, a cable connected to the driving circuit board, a control circuit board connected to the cable, and a connector disposed on the driving circuit board or the control circuit board to connect the cable to the driving circuit board or the control circuit board, wherein the connector includes a case in which an open area is formed, and an actuator rotatably disposed in the open area of the case to open and close at least a portion of the open area through the rotation, wherein the actuator comprises a hook extending from the actuator in a direction perpendicular to a direction to which a rotation axis extends, and wherein the case comprises a locking portion in which the hook is inserted when the actuator closes at least the portion of the open area through the rotation.

In the connector and a display device according to the present disclosure, by forming a hook and a locking portion coupling a case and an actuator of the connector in a direction perpendicular to the direction in which the axis of rotation of the actuator extends, even when the actuator is deformed in the direction in which the axis of rotation of the actuator extends by the heat generated from the cable, there is an effect of preventing the cable from disconnecting from the connector since the coupling of the case and the actuator is not released.

The effects according to the embodiments of the present disclosure are not limited to those mentioned above and more various effects are included in the following description of the present disclosure.

### BRIEF DESCRIPTION OF THE DRAWINGS

The above and other aspects and features of the present disclosure will become more apparent by describing in detail example embodiments thereof with reference to the attached drawings, in which:

FIG. 1 is a plan view schematically illustrating a state in which a connection member of a display device according to one embodiment is bent;

FIG. 2 is a plan view schematically illustrating a state in which a connection member of a display device according to one embodiment is unfolded;

FIG. 3 is a partial side view of FIG. 2;

FIG. 4 is a cross-sectional view schematically illustrating a display panel of FIG. 3;

FIG. 5 is a plan view illustrating a driving circuit board, a cable, a control circuit board, and a connector in FIG. 2;

FIG. 6 is a plan view illustrating a connector of a display device according to one embodiment;

FIG. 7 is a front view of FIG. 6;

FIG. 8 is a plan view of the case of FIG. 6;

FIG. 9 is a plan view of the actuator of FIG. 6;

FIG. 10 is a plan view of a state in which the actuator in FIG. 6 is rotated to open a cable entry portion;

FIG. 11 is a plan view of a state in which the actuator in FIG. 7 is rotated to close a cable entry portion;

FIG. 12 is a side view showing how the cable is connected to the connector;

FIG. 13 is a side view of a state in which the cable is connected to the connector and is fixed to the case; and

FIG. 14 is an enlarged view of area A of FIG. 6.

FIG. 15 is a block diagram of an electronic device according to one embodiment of the present disclosure.

FIG. 16 is a schematic diagram of an electronic device according to various embodiments of the present disclosure.

### DETAILED DESCRIPTION OF THE EMBODIMENTS

Advantages and features of the present disclosure and methods to achieve them will become apparent from the descriptions of example embodiments hereinbelow with reference to the accompanying drawings. However, the present disclosure is not limited to example embodiments disclosed herein but may be implemented in various different ways. The example embodiments are provided for making the disclosure of the present disclosure thorough and for fully conveying the scope of the present disclosure to those skilled in the art. It is to be noted that the scope of the present disclosure is defined only by the claims.

As used herein, a phrase “an element A on an element B” refers to that the element A may be disposed directly on the element B and/or the element A may be disposed indirectly on the element B via another element C. Like reference numerals denote like elements throughout the descriptions. The figures, dimensions, ratios, angles, numbers of elements given in the drawings are merely illustrative and are not limiting.

Although terms such as first, second, etc. are used to distinguish arbitrarily between the elements such terms describe, and thus these terms are not necessarily intended to indicate temporal or other prioritization of such elements. These terms are used to merely distinguish one element from another. Accordingly, as used herein, a first element may be a second element within the technical scope of the present disclosure.

Features of various example embodiments of the present disclosure may be combined partially or totally. As will be clearly appreciated by those skilled in the art, technically various interactions and operations are possible. Various example embodiments can be practiced individually or in combination.

Hereinafter, example embodiments of the present disclosure will be described in detail with reference to the accompanying drawings.

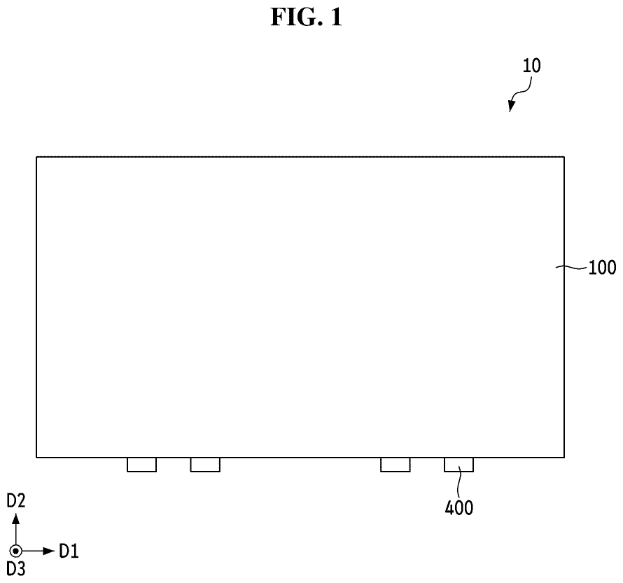

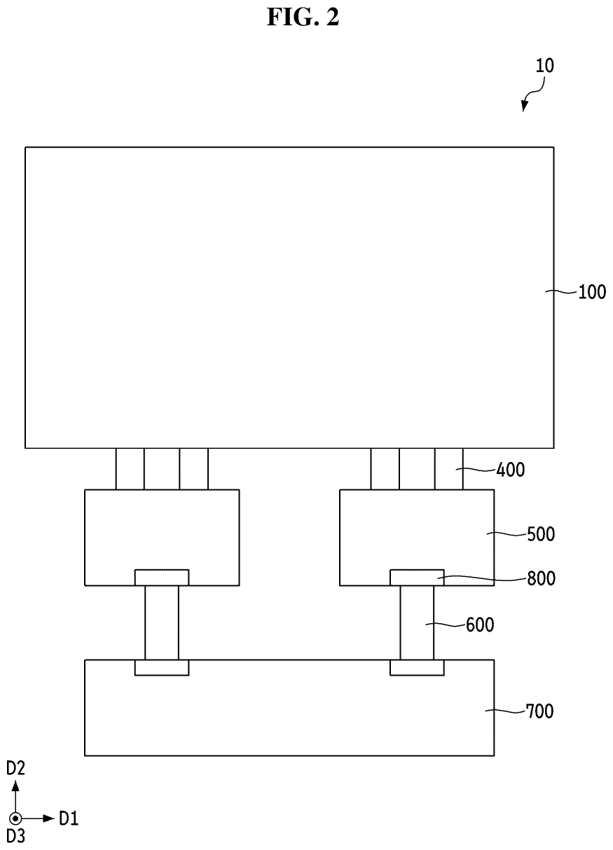

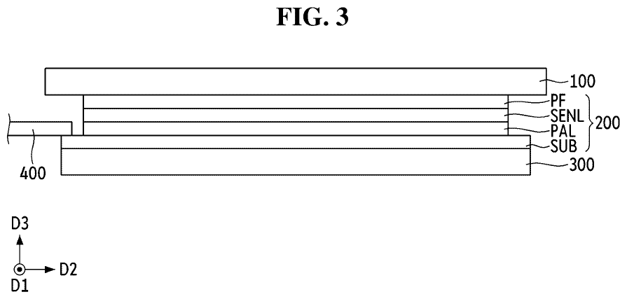

FIG. 1 is a plan view schematically illustrating a state in which a connection member of a display device according to one embodiment is folded. FIG. 2 is a plan view schematically illustrating a state in which a connection member of a display device according to one embodiment is unfolded. FIG. 3 is a partial side view of FIG. 2.

As used herein, a display device 10 according to one embodiment of the present disclosure is for displaying moving images or still images. The display device 10 may be used as a display screen for various products such as not only portable electronic devices such as mobile phones, smartphones, tablet personal computers (PCs), mobile communication terminals, electronic notebooks, e-books, portable multimedia players (PMPs), navigations, and ultra-mobile PCs (UMPCs), but also televisions (TVs), laptops, monitors, billboards, Internet of Things (IoT), or the like. According to an embodiment, the display device 10 may also be used in wearable devices such as smart watches, watch phones, glasses-type displays, or head mounted displays (HMDs). According to an embodiment, the display device 10 may also be used in dashboards of vehicles, center information displays (CIDs) of the center fascia or dashboards of vehicles, mirror displays that replace the side view mirrors of vehicles, and display screens arranged on the rear sides of front seats to serve as entertainment devices for back seat passengers of vehicles.

The display device 10 may be a light-emitting display device such as an organic light-emitting display device using organic light-emitting diodes, a quantum-dot light-emitting display device including quantum-dot light-emitting layer, an inorganic light-emitting display device including an inorganic semiconductor, and a micro light-emitting display device using micro light-emitting diodes (LED). In the following description, an organic light-emitting display device is described as an example of the display device 10. It is, however, to be understood that the present disclosure is not limited thereto.

As shown in FIG. 1, a first direction D1 may refer to a direction parallel to a side of the display device 10, for example, the horizontal direction of the display device 10 when viewed from the top. A second direction D2 may refer to a direction parallel to another side of the display device 10 that meet the side of the display device 10, for example, the vertical direction of the display device 10 when viewed from the top. A third direction D3 may refer to the thickness direction of the display device 10.

The display device 10 may have a quadrangular shape, such as a rectangular shape when viewed from the top. For example, the display device 10 may have a planar rectangular shape having long sides along a first direction D1 and short sides along a second direction D2. The corner where the long side extending along the first direction D1 and the short side extending along the second direction D2 meet may be rounded to have a predetermined curvature or may be right-angled. The planar shape of the display device 10 is not limited to the rectangular shape, and may be formed in another polygonal shape, a circular shape or an elliptical shape.

The display device 10 may include the display area and a non-display area. The shape of the display area may follow the shape of the display device 10 when viewed from the top. For example, when the display device 10 has a rectangular shape when viewed from the top, the display area may also have a rectangular shape when viewed from the top.

The display area may include a plurality of pixels to display images. The non-display area may not include pixels and thus may not display images. The non-display area may be disposed around the display area. The non-display area may surround the display area, but the embodiments of the present disclosure are not limited thereto. The display area may be partially surrounded by the non-display area.

Referring to FIGS. 1 to 3, the display device 10 according to one embodiment of the present disclosure may include a cover window 100, a display panel 200, a panel lower member 300, a connection member 400, a driving circuit board 500, a cable 600, a control circuit board 700, and a connector 800.

The cover window 100 may include a material with high light transmittance. The cover window 100 may include a polymer resin such as polyimide or glass. The cover window 100 may be attached to a polarizing film PF of the display panel 200 to be described later by an adhesive member such as an optically clear adhesive (OCA) film.

The display panel 200 may be disposed under the cover window 100. The display panel 200 may have a rectangular shape having long sides in the first direction D1 and short sides in the second direction D2 when viewed from the top. In the display panel 200, the corners where the long sides in the first direction D1 meet the short sides in the second direction D2 may be formed at a right angle or may be rounded with a predetermined curvature. The display panel 200 may have a quadrangular shape other than the rectangular shape, a polygonal shape other than a rectangular shape, a circular shape, an oval shape, or an irregular shape when viewed from the top.

The display panel 200 may include a display area where a plurality of emission areas that emits light is arranged, and a non-display area disposed around the display area. The non-display area may surround the display area. A plurality of display pads may be disposed in the non-display area at one edge of the display panel 200.

The display panel 200 may include a substrate SUB, a display unit PAL, a sensor unit SENL, and a polarizing film PF.

The substrate SUB may be made of an insulating material such as glass, quartz and a polymer resin. The substrate SUB may be a rigid substrate or a flexible substrate that can be bent, folded, rolled, and so on.

The display unit PAL may be disposed on the substrate SUB. The display unit PAL may be a layer including a plurality of emission areas that emit light. The display unit PAL may include a buffer film, a thin-film transistor layer on which thin-film transistors are disposed, a light-emitting element layer that emits light, and an encapsulating layer for encapsulating the light-emitting element layer.

The sensor unit SENL may be disposed on the display unit PAL. The sensor unit SENL may include sensor electrodes and may sense whether there is a user's touch.

The polarizing film PF may be disposed on the sensor unit SENL. The polarizing film PF may prevent the deterioration of image visibility of the display panel 200 due to reflection of external light. The polarizing film PF may include a linear polarizer and a retardation film such as a ¼ (quarter-wave) plate. The retardation film may be disposed on the sensor unit SENL and the linear polarizer may be disposed on the retardation film. The cover window 100 may be disposed on the polarizing film PF.

The panel lower member 300 may be disposed under the substrate SUB. The panel lower member 300 may be attached to a lower surface of the substrate SUB by an adhesive member. The adhesive member may be a pressure sensitive adhesive (PSA). The panel lower member 300 may include at least one among a light absorbing member for absorbing light incident from the outside, a buffer member for absorbing external shock, and a heat dissipation member for efficiently dissipating the heat of the display panel 200.

The light absorbing member may be disposed under the substrate SUB. The light absorbing member blocks transmission of light to prevent elements disposed under the light absorbing member, for example, the driving circuit board 500 from being seen from above the display panel 200. The light absorbing member may include a light absorbing material such as a black pigment or dye.

The buffer member may be disposed under the light absorbing member. The buffer member absorbs external shock to prevent the display panel 200 from being damaged. The buffer member may be composed of a single layer or a plurality of layers. For example, the buffer member may be made of polymer resin such as polyurethane, polycarbonate, polypropylene or polyethylene or may be made of an elastic material such as rubber, a urethane-based material or a sponge formed by foaming an acrylic material.

The heat dissipation member may be disposed under the buffer member. The heat dissipation member may include a first heat dissipation layer including graphite or carbon nanotubes and a second heat dissipation layer formed of a thin metal film such as copper, nickel, ferrite or silver capable of shielding electromagnetic waves and having excellent thermal conductivity.

The connection member 400 may be connected to the plurality of display pads of the display panel 200 through a conductive adhesive member such as an anisotropic conductive film. Accordingly, the display panel 200 and the connection member 400 may be electrically connected to each other.

In addition, the connection member 400 may be connected to a plurality of circuit pads of the driving circuit board 500 through a conductive adhesive member such as an anisotropic conductive film. Accordingly, connection member 400 and the driving circuit board 500 may be electrically connected to each other.

The connection member 400 may be a flexible printed circuit board or a chip on film.

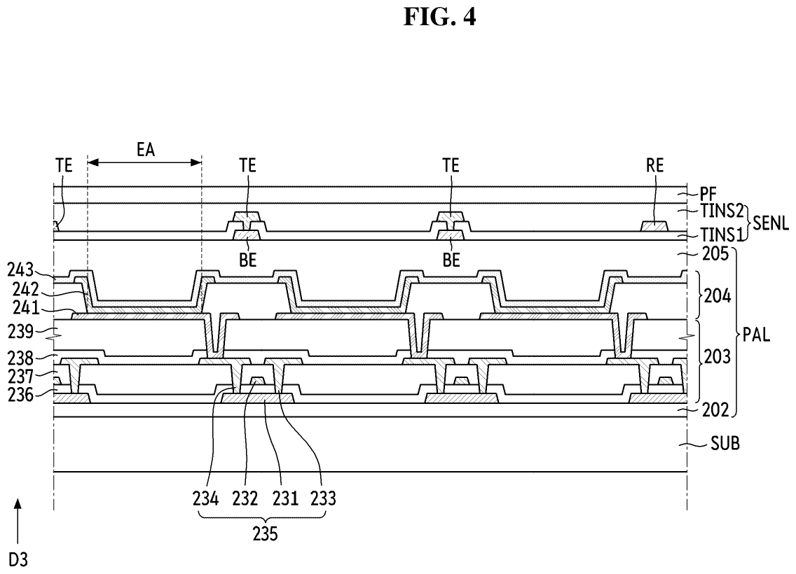

FIG. 4 is a cross-sectional view schematically illustrating a display panel of FIG. 3.

Referring to FIG. 4, the display unit PAL may include a buffer film 202, a thin-film transistor layer 203, a light emitting element layer 204, and an encapsulation layer 205.

The buffer film 202 may be formed on the substrate SUB. The buffer film 202 may be formed on the substrate SUB to protect the thin-film transistors 235 and the light-emitting elements from moisture permeating through the substrate SUB that is susceptible to moisture permeation. The buffer film 202 may be formed of a plurality of inorganic layers stacked on one another alternately. For example, the buffer film 202 may include multiple layers in which one or more inorganic layer of a silicon oxide layer (SiOx), a silicon nitride layer (SiNx) and SiON are stacked on one another alternately. The buffer film 202 may be eliminated.

The thin-film transistor layer 203 is formed on the buffer film 202. The thin-film transistor layer 203 includes thin-film transistors 235, a gate insulating layer 236, an interlayer dielectric layer 237, a protective film 238, and an organic film 239.

Each of the thin-film transistors 235 includes an active layer 231, a gate electrode 232, a source electrode 233, and a drain electrode 234. In FIG. 4, the thin-film transistors 235 are implemented as top-gate transistors in which each of the gate electrodes 232 is located above the active layer 231. It is, however, to be understood that the present disclosure is not limited thereto. That is to say, the thin-film transistors 235 may be implemented as bottom-gate transistors in which each of the gate electrodes 232 is located below the active layer 231, or as double-gate transistors in which the gate electrodes 232 are disposed above and below the active layer 231.

The active layer 231 is formed on the buffer film 202. The active layer 231 may be formed of a silicon-based semiconductor material or an oxide-based semiconductor material. For example, the active layer 231 may be formed of polycrystalline silicon, amorphous silicon, or an oxide semiconductor. A light-blocking layer for blocking external light incident on the active layer 231 may be formed between the buffer film 202 and the active layer 231.

The gate insulating layer 236 may be formed on the active layer 231. The gate insulating layer 236 may be formed of an inorganic layer, for example, a silicon oxide layer (SiOx), a silicon nitride layer (SiNx), or a multilayer thereof.

The gate electrodes 232 may be formed on the gate insulating layer 236. The gate electrodes 232 and the gate lines may be made up of a single layer or multiple layers of one of molybdenum (Mo), aluminum (Al), chromium (Cr), gold (Au), titanium (Ti), nickel (Ni), neodymium (Nd) and copper (Cu) or an alloy thereof.

The interlayer dielectric layer 237 may be formed over the gate electrodes 232 and the gate lines. The interlayer dielectric layer 237 may be formed of an inorganic layer, for example, a silicon oxide layer (SiOx), a silicon nitride layer (SiNx), or a multilayer thereof.

The source electrodes 233 and the drain electrodes 234 may be formed on the interlayer dielectric layer 237. Each of the source electrodes 233 and the drain electrodes 234 may be connected to the active layer 231 through a contact hole penetrating through the gate insulating layer 236 and the interlayer dielectric layer 237. The source electrode 233 and the drain electrode 234 may be a single layer or multiple layers of one of molybdenum (Mo), aluminum (Al), chromium (Cr), gold (Au), titanium (Ti), nickel (Ni), neodymium (Nd) and copper (Cu) or an alloy thereof.

The protective film 238 may be formed on the source electrode 233 and the drain electrode 234 in order to insulate the thin-film transistors 235. The protective film 238 may be formed of an inorganic layer, e.g., a silicon oxide layer (SiOx), a silicon nitride layer (SiNx), or a multilayer thereof.

The organic film 239 may be formed on the protective film 238 to provide a flat surface over the thin-film transistors 235 having difference levels. The organic film 239 may be implemented as an organic layer such as an acryl resin, an epoxy resin, a phenolic resin, a polyamide resin and a polyimide resin.

The light emitting element layer 204 is formed on the thin-film transistor layer 203. The light emitting element layer 204 includes the light-emitting elements and a bank.

The light-emitting elements and the bank are formed on the organic film 239. An organic light emitting element including an anode electrode 241, emissive layers 242 and a cathode electrode 243 is employed as an example of the light-emitting elements.

The anode electrode 241 may be formed on the organic film 239. The anode electrode 241 may be connected to the drain electrode 234 of the thin-film transistor 235 via a contact hole penetrating through the protective film 238 and the organic film 239.

The bank may be formed to cover edges of the anode electrode 241 on the organic film 239 to define the emission areas EA of the pixels. That is to say, the bank may define the emission areas EA of the pixels. In each of the pixels, the anode electrode 241, the emissive layer 242 and the cathode electrode 243 are sequentially stacked on one another so that holes from the anode electrode 241 and electrons from the cathode electrode 243 combine in the emissive layer 242 to emit light.

The emissive layer 242 is formed on the anode electrode 241 and the bank. The emissive layer 242 may be an organic emissive layer. The emissive layer 242 may emit one of red light, green light, and blue light. Alternatively, the emissive layer 242 may be a white emissive layer that emits white light. In such case, the red emissive layer, the green emissive layer and the blue emissive layer may be stacked on one another or may be formed commonly across the pixels as a common layer. In such case, the display panel 200 may further include additional color filters for representing red, green and blue colors.

The emissive layer 242 may include a hole transporting layer, a light-emitting layer, and an electron transporting layer. In addition, the emissive layer 242 may be formed in a tandem structure of two or more stacks, in which case a charge generating layer may be formed between the stacks.

The cathode electrode 243 is formed on the emissive layer 242. The cathode electrode 243 may be formed to cover the emissive layer 242. The cathode electrode 243 may be a common layer formed across the pixels.

When the light emitting element layer 204 is of a top-emission type in which light exits toward the upper side, the anode electrode 241 may be made of a metal material having a high reflectivity such as a stack structure of aluminum and titanium (Ti/Al/Ti), a stack structure of aluminum and ITO (ITO/Al/ITO), an APC alloy and a stack structure of APC alloy and ITO (ITO/APC/ITO). The APC alloy is an alloy of silver (Ag), palladium (Pd) and copper (Cu). The cathode electrode 243 may be formed of a transparent conductive material (TCP) such as ITO and IZO that can transmit light, or a semi-transmissive conductive material such as magnesium (Mg), silver (Ag) and an alloy of magnesium (Mg) and silver (Ag). When the cathode electrode 243 is formed of a semi-transmissive conductive material, the light extraction efficiency can be increased by using microcavities.

When the light emitting element layer 204 is of a bottom-emission type in which light exits toward the lower side, the anode electrode 241 may be formed of a transparent conductive material (TCP) such as ITO and IZO that can transmit light, or a semi-transmissive conductive material such as magnesium (Mg), silver (Ag) and an alloy of magnesium (Mg) and silver (Ag). The cathode electrode 243 may be made of a metal material having a high reflectivity such as a stack structure of aluminum and titanium (Ti/Al/Ti), a stack structure of aluminum and ITO (ITO/Al/ITO), an APC alloy and a stack structure of APC alloy and ITO (ITO/APC/ITO). When the anode electrode 241 is formed of a semi-transmissive conductive material, the light extraction efficiency can be increased by using microcavities.

The encapsulation layer 205 is formed on the light emitting element layer 204. The encapsulation layer 205 serves to prevent permeation of oxygen or moisture into the emissive layer 242 and the cathode electrode 243. To this end, the encapsulation layer 205 may include at least one inorganic layer. The inorganic layer may be formed of silicon nitride, aluminum nitride, zirconium nitride, titanium nitride, hafnium nitride, tantalum nitride, silicon oxide, aluminum oxide, or titanium oxide. Further, the encapsulation layer 205 may further include at least one organic layer. The organic film may have a sufficient thickness to prevent particles from permeating into the encapsulation layer 205 and entering the emissive layer 242 and the cathode electrode 243. The organic layer may include one of epoxy, acrylate and urethane acrylate.

The sensor unit SENL may be formed on the encapsulation layer 205. When the sensor unit SENL is formed directly on the encapsulation layer 205, the thickness of the display device 10 can be reduced compared with a display device in which a separate touch panel is attached on the encapsulation layer.

The sensor unit SENL may include sensor electrodes for sensing a user's touch by capacitive sensing, and touch lines for connecting touch pads with the sensor electrodes. For example, the sensor unit SENL can sense a user's touch by self-capacitance sensing or mutual capacitance sensing. In the example shown in FIG. 4, the sensor unit SENL includes two layers including driving electrodes TE, sensing electrodes RE and bridges BE connecting between the driving electrodes TE for mutual capacitance sensing.

The bridges BE may be formed on the encapsulation layer 205. The bridges BE may include, but is not limited to, a stack structure of aluminum and titanium (Ti/Al/Ti), a stack structure of aluminum and ITO (ITO/Al/ITO), an APC alloy and a stack structure of APC alloy and ITO (ITO/APC/ITO). For example, the bridges BE may include a single layer of molybdenum (Mo), titanium (Ti), copper (Cu), aluminum (Al) or ITO.

A first sensing insulating film TINS1 is formed over the bridges BE. The first sensing insulating film TINS1 may be formed of an inorganic layer, for example, a silicon nitride layer, a silicon oxynitride layer, a silicon oxide layer, a titanium oxide layer, or an aluminum oxide layer.

The driving electrodes TE and the sensing electrodes RE may be formed on the first sensing insulating film TINS1. The driving electrode TE and the sensing electrode RE may be formed as, but is not limited to, a stack structure of aluminum and titanium (Ti/Al/Ti), a stack structure of aluminum and ITO (ITO/Al/ITO), an APC alloy and a stack structure of APC alloy and ITO (ITO/APC/ITO). For example, the driving electrodes TE and the sensing electrodes RE may be a single layer of molybdenum (Mo), titanium (Ti), copper (Cu), aluminum (Al) or ITO.

Contact holes may be formed in the first sensing insulating film TINS1 which penetrate the first sensing insulating film TINS1 to expose the bridges BE before the driving electrodes TE and the sensing electrodes RE are formed when forming the sensor unit SENL. The driving electrodes TE may be connected to the bridges BE through the contact holes.

A second sensing insulating film TINS2 is formed over the driving electrodes TE and the sensing electrodes RE. The second sensing insulating film TINS2 may provide a flat surface over the driving electrodes TE, the sensing electrodes RE and the bridges BE which have different heights. The second sensing insulating film TINS2 may be formed of an organic layer such as an acryl resin, an epoxy resin, a phenolic resin, a polyamide resin and a polyimide resin.

The bridges BE connecting between the adjacent driving electrodes TE may be disposed on the encapsulation layer 205, and the driving electrodes TE and the sensing electrodes RE may be disposed on the first sensing insulating film TINS1. Therefore, the driving electrodes TE and the sensing electrodes RE may be electrically separated from each other at their intersections, while the sensing electrodes RE may be electrically connected with one another in one direction, and the driving electrodes TE may be electrically connected with one another in another direction.

The polarizing film PF may be disposed on the second sensing insulating film TINS2 and may prevent the deterioration of image visibility of the display panel 200 due to reflection of external light.

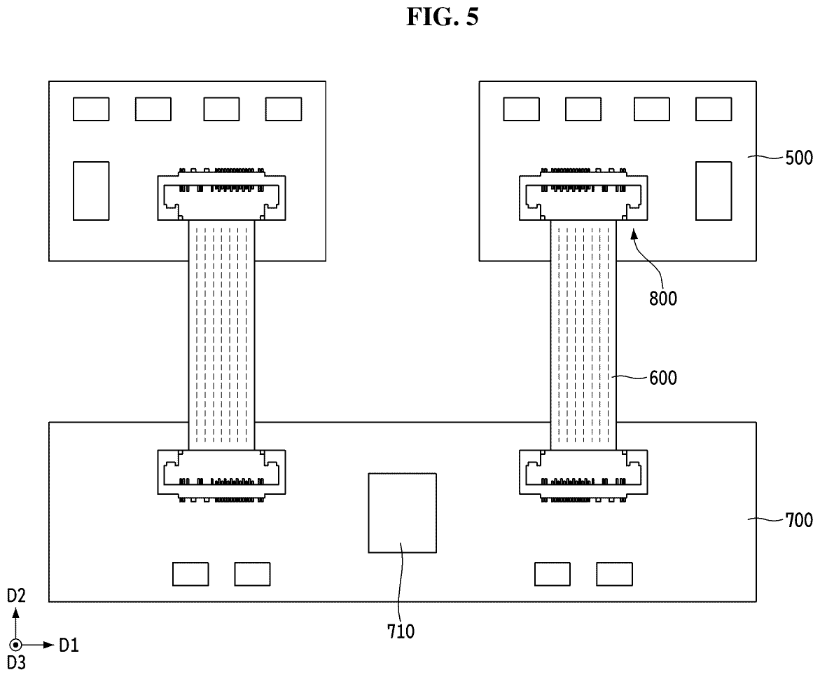

FIG. 5 is a plan view illustrating a driving circuit board, a cable, a control circuit board, and a connector in FIG. 2.

Referring to FIG. 5, when the connection member 400 is folded, the driving circuit board 500 may be disposed under the panel lower member 300. The driving circuit board 500 may be a flexible printed circuit board (FPCB) that may be bent, a rigid printed circuit board (PCB) that is rigid and thus is not easily bent, or a composite printed circuit board that includes both a rigid printed circuit board and a flexible printed circuit board.

The driving circuit board 500 may process the signal converted by an integrated circuit chip 710 disposed on the control circuit board 700 and transmit it to the display panel 200. The driving circuit board 500 may be electrically connected to the display panel 200 through the connection member 400.

The cable 600 may connect the driving circuit board 500 and the control circuit board 700. As both sides of the cable 600 are connected to the connector 800 disposed on one surface of each of the driving circuit board 500 and the control circuit board 700, the driving circuit board 500 and the control circuit board 700 may be connected.

The connection terminal (not shown) are disposed on both sides of the cable 600, and when the cable 600 is connected to the connector 800, the connection terminal of the cable 600 may be connected to a connection pin 812 of the connector to be described later. As described above, the cable 600 connecting the driving circuit board 500 and the control circuit board 700 may provide a path through which signals converted from the integrated circuit chip 710 disposed on the control circuit board 700 are transmitted to the driving circuit board 500.

The control circuit board 700 may be connected to the driving circuit board 500 and may be disposed under the panel lower member 300 when the connection member 400 is folded. The control circuit board 700 may be a flexible printed circuit board (FPCB) that may be bent, a rigid printed circuit board (PCB) that is rigid and thus is not easily bent, or a composite printed circuit board that includes both a rigid printed circuit board and a flexible printed circuit board.

The integrated circuit chip 710 on the control circuit board 700 may convert signals for implementing images and signals supplied from a system that supplies power into signals for supplying to the display panel 200. The control circuit board 700 may include the integrated circuit chip 710 that converts signals supplied from the system. The control circuit board 700 may be electrically connected to the driving circuit board 500 by the cable 600.

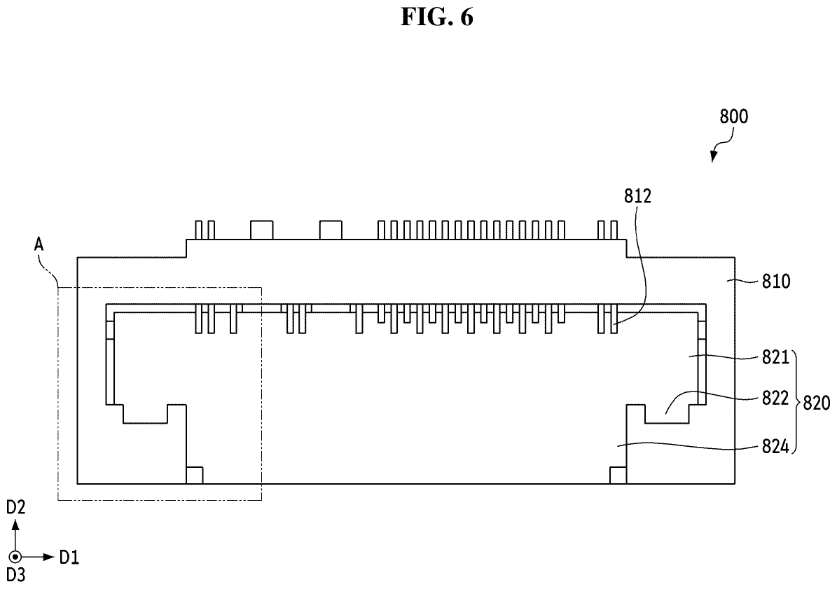

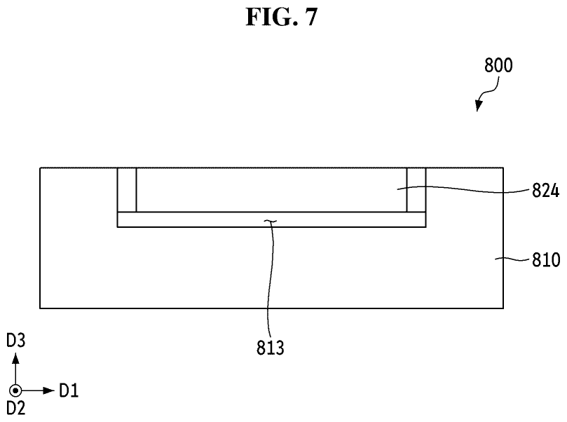

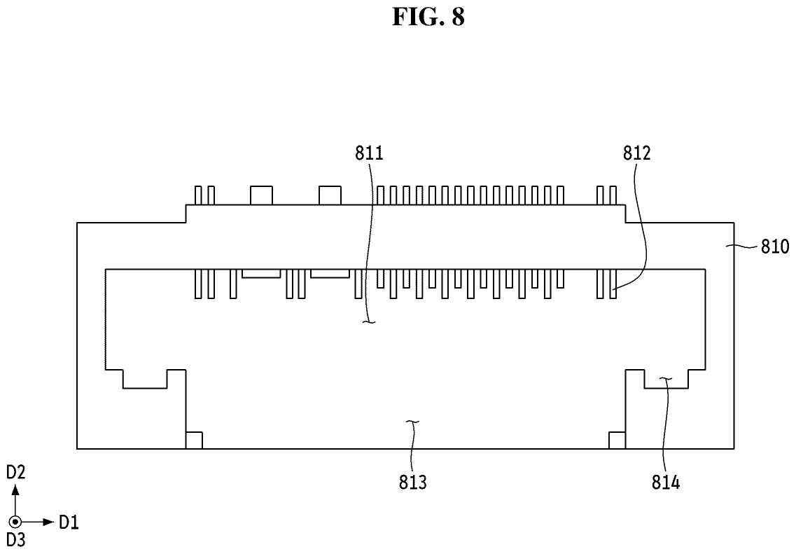

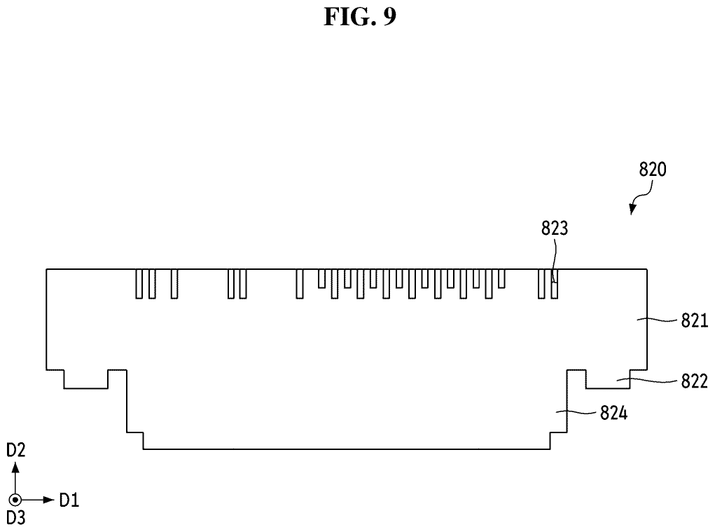

FIG. 6 is a plan view illustrating a connector of a display device according to one embodiment. FIG. 7 is a front view of FIG. 6. FIG. 8 is a plan view of the case of FIG. 6. FIG. 9 is a plan view of the actuator of FIG. 6.

Referring to FIGS. 6 to 9, the connector 800 may be disposed on one surface of each of the driving circuit board 500 and the control circuit board 700 to connect the driving circuit board 500 and control circuit board 700 to the cable 600. The connector 800 may include a case 810 and an actuator 820.

The case 810 may have a quadrangular shape, such as a rectangular shape when viewed from the top. For example, the case 810 may have a planar rectangular shape having long sides along a first direction D1 and short sides along a second direction D2. The case 810 may have a predetermined thickness in a third direction D3 perpendicular to the first direction D1 and the second direction D2. In other words, the case 810 may be formed in the shape of an approximately rectangular square box.

An open area may be formed in the case 810. The open area may be an area extending from an inside to an outside of the case 810, and may be a hollow space formed by removing a portion of the case 810. The open area may include a cable seating portion 811 and a cable entry portion 813.

The cable seating portion 811 may extend from the inside of the case 810 in the third direction D3. The cable seating portion 811 may be a hollow space formed by removing a portion of the case 810. The cable seating portion 811 may provide a space for the cable 600, which has entered the inside of the case 810 through the cable entry portion 813, to be mounted.

A plurality of connection pins 812 may extend from the case 810 toward the cable seating portion 811. The plurality of connection pins 812 may extend from the case 810 toward the cable seating portion 811. The plurality of connection pins 812 extending from the case 810 may be connected to signal lines of the control circuit board 700 or the driving circuit board 500. The plurality of connection pins 812 may be connected to the connection terminal of the cable 600 mounted on the cable seating portion 811.

The cable entry portion 813 may extend from the cable seating portion 811 in the second direction D2. The cable entry portion 813 may be a space formed by removing a portion of the case 810. The cable entry portion 813 may provide a space for the cable 600 to enter the inside of the case 810.

The case 810 may further include a locking portion 814. The locking portion 814 may be a portion recessed from an edge of the case 810 in the second direction D2. The locking portion 814 may be a hollow space formed by removing a portion of the case 810. In other words, the locking portion 814 may be provided as a groove recessed from the inner surface of the case in the second direction D2. The locking portion 814 may be formed in a shape corresponding to a hook 822 to be described later.

The locking portion 814 may be provided in a plural number, and the plurality of locking portions 814 may include a first locking portion disposed on one side of the case 810 and a second locking portion disposed on another side of the case. The first locking portion and the second locking portion may be spaced apart from each other in the first direction D1.

The first locking portion may extend from the left inner surface of FIG. 8 among the inner surface of the case 810 forming the cable seating portion 811 in the second direction D2, and the second locking portion may extend from the right inner surface of FIG. 8 among the inner surface of the case 810 forming the cable seating portion 811 in the second direction D2. The first locking portion and the second locking portion may be spaced apart from each other so that the cable entry portion 813 is disposed therebetween.

The actuator 820 may be rotatably connected to the case 810 and disposed on an open area of the case 810. The actuator 820 may open and close at least a portion of the open area through the rotation. The actuator 820 may include a rotation portion 821, the hook 822, and an opening/closing portion 824.

The rotation portion 821 may be rotatably disposed on the cable seating portion 811. The rotation portion 821 may extend from the inner surface of the cable seating portion 811 in the first direction D1. One side and the other side of the rotation portion 821 may be rotatably connected to the inner surface of the case 810 forming the cable seating portion 811. The rotation portion 821 may rotate with respect to the case 810 with a rotation axis extending in the first direction D1 as the center of rotation. The rotation portion 821 may open or close at least a portion of the cable seating portion 811 through the rotation.

A plurality of connection pin insertion portions 823 may be formed in the rotation portion 821. The connection pin insertion portion 823 may be a hollow space formed by removing a portion of the rotation portion 821. When the rotation portion 821 is disposed on the cable seating portion 811, the connection pins 812 disposed on the cable seating portion 811 may be inserted into the connection pin insertion portions 823, respectively.

The hook 822 may extend in the direction perpendicular to the direction to which the rotation center of the rotation portion 821 extends. In other words, the hook 822 may extend from the rotation portion 821 in the second direction D2. The hook 822 may be formed in a shape engaging with the locking portion 814. The hook 822 may be inserted into the locking portion 814 when the rotation portion 821 is rotated to close at least a portion of the cable seating portion 811.

The hook 822 may be provided in a plural number, and the plurality of hooks 822 may include a first hook disposed on one side of the actuator 820 and a second hook disposed on another side of the actuator 820. The first hook and the second hook may be spaced apart from each other in the first direction D1.

The first hook may extend from the left side of FIG. 9 of the rotation portion 821 in the second direction D2, and the second hook may extend from the right side of FIG. 9 of the rotation portion 821 in the second direction D2. The first hook and the second hook are spaced apart so that the opening/closing portion 824 is disposed therebetween.

When the rotation portion 821 is rotated to close at least a portion of the cable seating portion 811, the first hook may be inserted into the first locking portion, and the second hook may be inserted into the second locking portion.

The opening/closing portion 824 may extend from the rotation portion 821 in the second direction D2. The extension length of the opening/closing portion 824 may correspond to the length of the cable entry portion 813 in the second direction D2, and the width of the opening/closing portion 824 in the first direction D1 may correspond to the length of the cable entry portion 813 in the first direction D1.

The opening/closing portion 824 may open or close at least a portion of the cable entry portion 813 through the rotation.

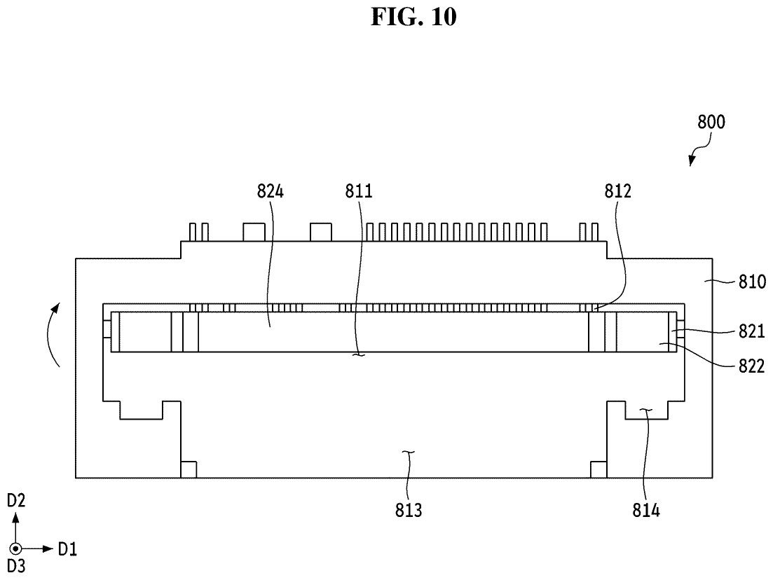

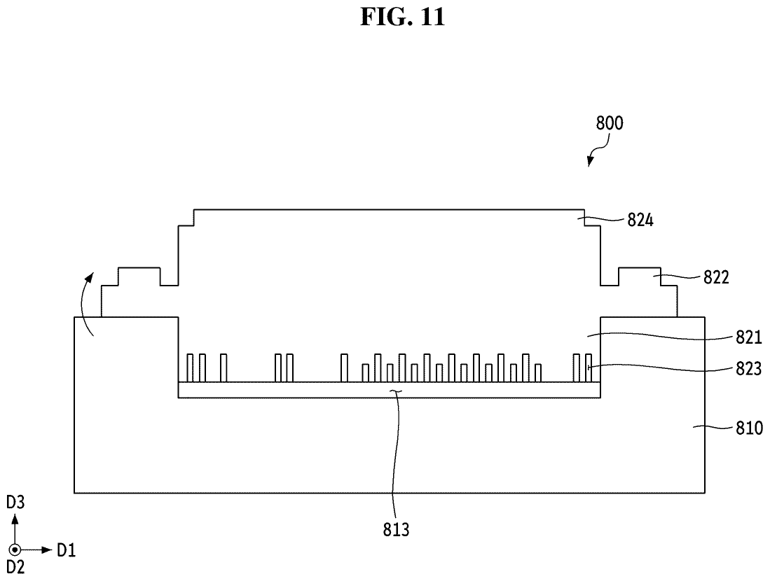

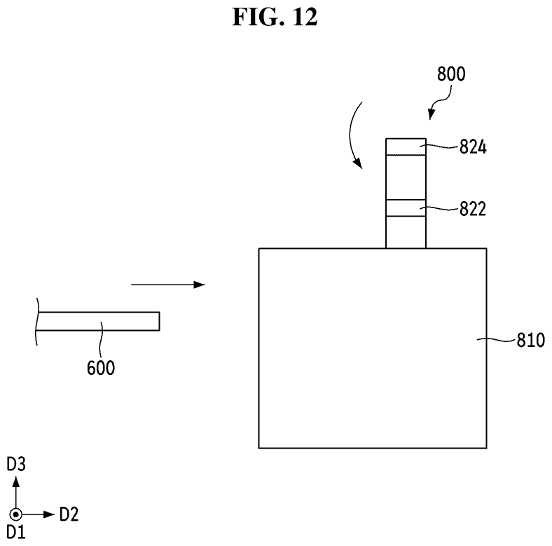

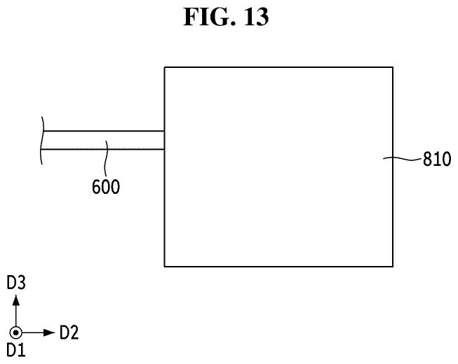

FIG. 10 is a plan view of a state in which the actuator in FIG. 6 is rotated to open the open area. FIG. 11 is a plan view of a state in which the actuator in FIG. 7 is rotated to close the open area. FIG. 12 is a side view of a state in which the cable enters the connector. FIG. 13 is a side view of a state in which the cable enters the connector and is fixed to the case.

Referring to FIGS. 10 and 13, in a state where the actuator 820 is closing the cable seating portion 811 and the cable entry portion 813 of the case 810, the rotation portion 821 may rotate and open the cable seating portion 811 and the cable entry portion 813. When the cable seating portion 811 and the cable entry portion 813 are open through the rotation of the rotation portion 821, the cable 600 may enter inside the case 810 through the rotation.

The cable 600 that has entered the inside of the case 810 through the cable entry portion 813 may be mounted in the cable seating portion 811, and the connection terminal of the cable 600 mounted in the cable seating portion 811 may be connected to the connection pin 812 mounted on the cable seating portion 811.

When the cable 600 is mounted on the cable seating portion 811 and the connection terminal of the cable 600 is connected to the connection pin 812, the rotation portion 821 may rotate so that the actuator 820 may close at least a portion of the cable seating portion 811 and the cable entry portion 813.

When the actuator 820 rotates to close at least a portion of the cable seating portion 811 and the cable entry portion 813, the hook 822 may be inserted into the locking portion 814.

When the actuator 820 closes at least a portion of the cable seating portion 811 and the cable entry portion 813, the end of the cable 600 mounted in the cable seating portion 811 is pressed by the rotation portion 821 and the cable 600 disposed in the cable entry portion 813 is pressed by the opening/closing portion 824 so that the cable 600 can be fixed to the connector 800.

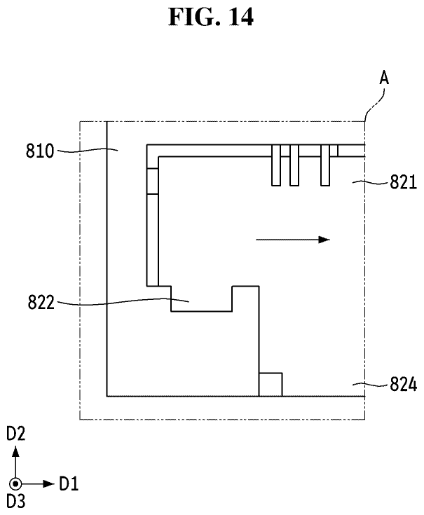

FIG. 14 is an enlarged view of area A of FIG. 6.

Referring to FIG. 14, in a state where the cable 600 is fixed to the connector 800 through a rotation of the actuator 820, the rotation portion 821 may be deformed in the first direction D1 by heat generated from the cable 600 when the display device 10 operates. However, since the hook 822 and the locking portion 814 are formed in the second direction D2 perpendicular to the first direction D1 and coupled to each other, the coupling of the hook 822 and the locking portion 814 may not be released even when the rotation portion 821 is deformed in the first direction D1. In other words, even when the actuator 820 is deformed by the heat generated from the cable 600, the coupling of the hook 822 and the locking portion 814 may not be released, thereby preventing the cable 600 from disconnected from the connector 800.

The display device according to one embodiment of the present disclosure can be applied to various electronic devices. The electronic device according to the one embodiment of the present disclosure includes the display device described above, and may further include modules or devices having additional functions in addition to the display device.

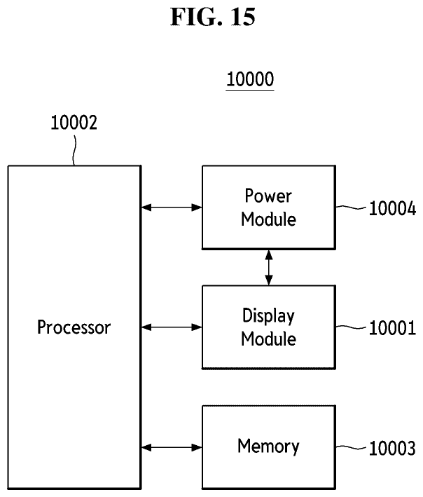

FIG. 15 is a block diagram of an electronic device according to one embodiment of the present disclosure.

Referring to FIG. 15, the electronic device 10000 according to one embodiment of the present disclosure may include a display module 10001, a processor 10002, a memory 10003, and a power module 10004.

The processor 10002 may include at least one of a central processing unit (CPU), an application processor (AP), a graphic processing unit (GPU), a communication processor (CP), an image signal processor (ISP), and a controller.

The memory 10003 may store data information necessary for the operation of the processor 10002 or the display module 10001. When the processor 10002 executes an application stored in the memory 10003, an image data signal and/or an input control signal is transmitted to the display module 10001, and the display module 10001 can process the received signal and output image information through a display screen.

The power module 10004 may include a power supply module such as, for example a power adapter or a battery, and a power conversion module that converts the power supplied by the power supply module to generate power necessary for the operation of the electronic device 10000.

At least one of the components of the electronic device 10000 according to the one embodiment of the present disclosure may be included in the display device according to the embodiments of the present disclosure. In addition, some modules of the individual modules functionally included in one module may be included in the display device, and other modules may be provided separately from the display device. For example, the display device may include the display module 10001, and the processor 10002, the memory 10003, and the power module 10004 may be provided in the form of other devices within the electronic device 10000 other than the display device.

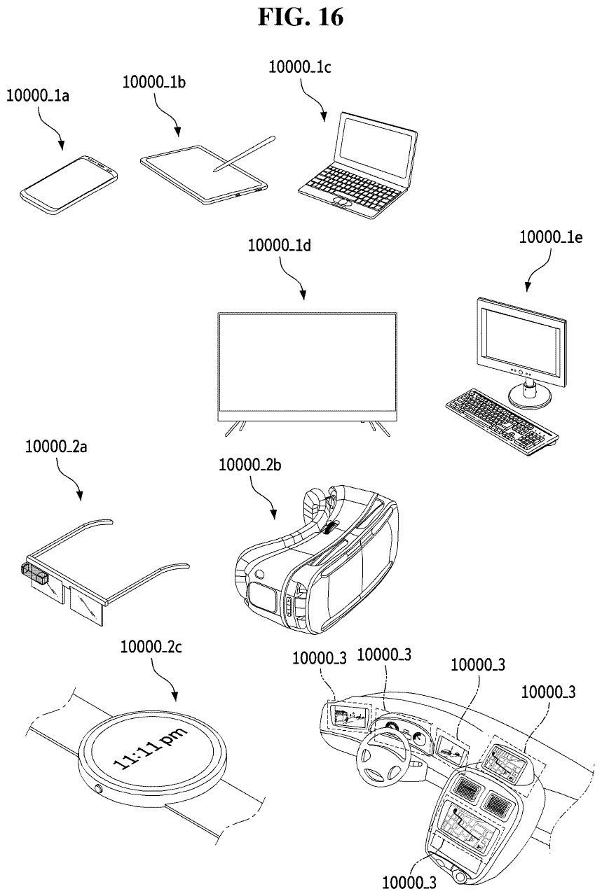

FIG. 16 is a schematic diagram of an electronic device according to various embodiments of the present disclosure.

Referring to FIG. 16, various electronic devices to which display devices according to embodiments of the present disclosure are applied may include not only image display electronic devices such as a smart phone 10000_1a, a tablet PC (personal computer) 10000_1b, a laptop 10000_1c, a TV 10000_1d, and a desk monitor 10000_1e, but also wearable electronic devices including display modules such as, for example smart glasses 10000_2a, a head mounted display 10000_2b, and a smart watch 10000_2c, and vehicle electronic devices 10000_3 including display modules such as a CID (Center Information Display) and a room mirror display arranged on a dashboard, center fascia, and dashboard of an automobile.

It should be understood, however, that the aspects and features of embodiments of the present disclosure are not restricted to the one set forth herein. The above and other aspects of the present disclosure will become more apparent to one of ordinary skill in the art to which the present disclosure pertains by referencing the claims, with equivalents thereof to be included therein.

What is claimed is:

1. A connector, comprising:
a case in which an open area is formed; and
an actuator rotatably disposed in the open area of the case to open and close at least a portion of the open area through the rotation,
wherein the actuator comprises a hook extending from the actuator in a direction perpendicular to a direction to which a rotation axis extends, and
wherein the case comprises a locking portion in which the hook is inserted when the actuator closes at least the portion of the open area through the rotation.

2. The connector of claim 1, wherein the open area comprises:
a cable entry portion providing a space for a cable to enter; and
a cable seating portion connected to the cable entry portion and providing a space for the cable that entered inside the case through the cable entry portion to be mounted.

3. The connector of claim 2, wherein the locking portion is recessed from an inner surface of the case in a direction to which the hook extends.

4. The connector of claim 2, wherein the locking portion is provided in plural number and the plurality of locking portions are spaced apart from each other so that the cable entry portion is disposed therebetween.

5. The connector of claim 2, wherein the case is disposed on one surface of a circuit board, and
wherein the case further comprises a plurality of connection pins connected to the circuit board and disposed in the cable seating portion.

6. The connector of claim 5, wherein the actuator further comprises a plurality of connection pin insertion portions in which the plurality of connection pins are inserted.

7. The connector of claim 2, wherein the actuator further comprises:
a rotation portion rotatably disposed on the cable seating portion; and
an opening/closing portion extending from the rotation portion to open/close at least a portion of the cable entry portion through the rotation.

8. The connector of claim 7, wherein the hook extends from the rotation portion.

9. The connector of claim 8, wherein the hook is provided in plural number and the plurality of hooks are spaced apart from each other so that the opening/closing portion is disposed therebetween.

10. The connector of claim 7, wherein the opening/closing portion extends in a direction to which the hook extends from the rotation portion.

11. The connector of claim 7, wherein, after the open area of the case is open and the cable is mounted on the cable seating portion through the cable entry portion, the actuator is rotated so that the cable mounted on the cable seating portion is pressed by the rotation portion and the cable disposed in the cable entry portion is pressed by the opening/closing portion.

12. A display device comprising:
a display panel;
a driving circuit board connected to the display panel;
a cable connected to the driving circuit board;
a control circuit board connected to the cable; and
a connector disposed on the driving circuit board or the control circuit board to connect the cable to the driving circuit board or the control circuit board,
wherein the connector comprises:
a case in which an open area is formed; and
an actuator rotatably disposed in the open area of the case to open and close at least a portion of the open area through the rotation,
wherein the actuator comprises a hook extending from the actuator in a direction perpendicular to a direction to which a rotation axis extends, and
wherein the case comprises a locking portion in which the hook is inserted when the actuator closes at least the portion of the open area through the rotation.

13. The display device of claim 12,
wherein the open area comprises:
a cable entry portion providing a space for the cable to enter; and
a cable seating portion connected to the cable entry portion and providing a space for the cable that entered inside the case through the cable entry portion to be mounted.

14. The display device of claim 13, wherein the locking portion is recessed from an inner surface of the case in a direction to which the hook extends.

15. The display device of claim 13, wherein the locking portion is provided in plural number and the plurality of locking portions are spaced apart from each other so that the cable entry portion is disposed therebetween.

16. The display device of claim 13, wherein the case is disposed on one surface of the driving circuit board or the control circuit board, and
wherein the case further comprises a plurality of connection pins connected to the driving circuit board or the control circuit board and extending toward the cable seating portion.

17. The display device of claim 13, wherein the actuator further comprises:
a rotation portion rotatably disposed on the cable rotation portion; and
opening/closing portion extending from the rotation portion to open/close at least a portion of the cable entry portion through the rotation.

18. The display device of claim 17, wherein the hook extends from the rotation portion.

19. The display device of claim 18, wherein the hook is provided in plural number and the plurality of hooks are spaced apart from each other so that the opening/closing portion is disposed therebetween.

20. An electronic device comprising:
a display panel;
a driving circuit board connected to the display panel;
a cable connected to the driving circuit board;
a control circuit board connected to the cable; and
a connector disposed on the driving circuit board or the control circuit board to connect the cable to the driving circuit board or the control circuit board,
wherein the connector comprises:
a case in which an open area is formed; and
an actuator rotatably disposed in the open area of the case to open and close at least a portion of the open area through the rotation,
wherein the actuator comprises a hook extending from the actuator in a direction perpendicular to a direction to which a rotation axis extends, and
wherein the case comprises a locking portion in which the hook is inserted when the actuator closes at least the portion of the open area through the rotation.
